(19) United States
(12) Patent Application Publication
(10) Pub. No.: US 2025/0083857 A1
(43) Pub. Date: Mar. 13, 2025

(54) OUTDOOR PATIO BOX

(71) Applicant: FINDLAY MACHINE & TOOL, LLC, Findlay, OH (US)

(72) Inventor: Nickolas Reinhart, Sarasota, FL (US)

(21) Appl. No.: 18/883,025

(22) Filed: Sep. 12, 2024

Related U.S. Application Data
(60) Provisional application No. 63/582,007, filed on Sep. 12, 2023.
(60) Provisional application No. 63/582,102, filed on Sep. 12, 2023.
(60) Provisional application No. 63/582,082, filed on Sep. 12, 2023.

(51) Int. Cl. B65D 1/26; B65D 1/46; B65D 21/02; B65D 25/24; B65D 25/28; B65D 43/16

(52) U.S. Cl. CPC B65D 1/26; B65D 1/46; B65D 21/0233; B65D 25/24; B65D 25/2888; B65D 43/164; B65D 2543/00194; B65D 2543/00296

(57) ABSTRACT

An outdoor patio box assembly includes a box body and a lid. The box body has a front wall, side walls, rear wall, and base with feet and spacers for nesting. The lid features channels, standoffs, and water drainage elements. The assembly facilitates efficient stacking and nesting through tapered walls, interlocking mechanisms, and strategic placement of features. The lid may have an inlaid design with a raised skirt, creating a containment area for stacked assemblies. The box body and lid are designed to enhance stability during stacking, improve storage and shipping efficiency, and provide effective water drainage.

### CROSS-REFERENCE TO RELATED APPLICATIONS

This application claims the benefit of U.S. Provisional Application No. 63/582,007, filed on Sep. 12, 2023; U.S. Provisional Application No. 63/582,082, filed on Sep. 12, 2023; and U.S. Provisional Application No. 63/582,102, filed on Sep. 12,2023. The entire disclosures of the above applications are incorporated herein by reference.

### FIELD

The present technology relates to outdoor storage containers constructed of plastic structural panels, and, more specifically, to a patio storage box.

### INTRODUCTION

This section provides background information related to the present disclosure which is not necessarily prior art.

Various plastic storage containers are used to hold various household items. Patios, porches, swimming pools, balconies, and boat docks are just a few places that benefit from weather-resistant storage containers for holding items associated with activities related to the location. Patio boxes may be used to store gardening supplies, pool supplies, beach supplies, furniture covers/cushions, towels, toys and so forth, all subject to the owner's individual preference. The patio box can be rectangular shaped, defining a storage area having front and rear walls, opposing end walls, a bottom wall, and a removable or hinged cover or lid. The patio box and the lid can each be formed of weather resistant materials to allow exposure to precipitation and sunlight. For ease of explanation, such containers are often referred to as patio boxes, which may be used interchangeably with terms like dock box, storage box, container box, storage container, or similar descriptive terms.

Certain patio boxes employ blow molded or extruded panels that are coupled together with connector members. These connector members facilitate an engagement between the panels to form a complimentary edge configuration. For ease of storage and shipping, the patio boxes are often manufactured in a disassembled configuration where the panels are coupled together to form the patio box by the end consumer. This approach, however, presents several challenges. The assembly requirement can be an inconvenience to the end consumer, potentially deterring them from purchasing the storage box. There is also a risk of incorrect assembly, which could compromise the functionality and durability of the patio box. Additionally, storage and shipping of disassembled patio boxes may not be as space-efficient as possible, leading to increased costs and logistical issues. Storage and shipping of fully assembled patio boxes and their lids, conversely, can present issues with stability and deformation of these components, as multiple units may be stacked atop one another and/or nested with respect to each other. This can lead to damage during transport and storage, reducing the quality and appeal of the product to consumers.

Outdoor storage containers are also subject to various weather conditions, including rain and other forms of precipitation. Water accumulation on the lid of a patio box can lead to various issues, such as water seepage into the container, damage to the lid or box structure over time such as caused by freezing and thawing, and potential instability when opening or closing the lid. Effective water drainage features are crucial to prevent these problems and ensure the longevity of the patio box. Sunlight can also affect the material(s) used in forming the patio box, as well as items stored within the patio box.

Another challenge faced by manufacturers and retailers of patio boxes is the need to maximize storage and shipping space relative to the number of components, while at the same time maintaining structural stability. This is particularly important when considering the weight and stresses that lids and patio boxes may experience when stacked and/or nested during storage and transportation. Nesting patio boxes during storage and/or shipping can maximize the number of units per area, in certain case, but can also present undesirable stress to certain components.

There is a continuing need for an outdoor patio box that addresses these various challenges. Desirably, such a patio box would reduce the assembly requirement for the end consumer, provide improved stability and durability during stacking and storage, facilitate efficient nesting for compact storage and shipping, incorporate effective water drainage features to prevent water accumulation and associated problems, and maximize storage and shipping efficiency while maintaining structural integrity.

### SUMMARY

In concordance with the instant disclosure, an outdoor patio box that provides improved stability and durability during stacking and storage, facilitate efficient nesting for compact storage and shipping, incorporate effective water drainage features to prevent water accumulation and associated problems, and maximize storage and shipping efficiency while maintaining structural integrity, has surprisingly been discovered.

The present technology includes articles of manufacture, systems, and processes that relate to nestable and stackable outdoor patio boxes with improved lid designs for efficient organization, protection, and water drainage.

In certain embodiments, an outdoor patio box can include a box body with a front wall, a pair of side walls, a rear wall, and a base. The walls can be disposed around the edges of the base. The box body can also include a foot formed on the exterior surface of the base and a spacer formed on the inner surface of the base opposite the foot.

In certain embodiments, a stack of patio box bodies can include a first box body as described herein and a second box body nested within the first box body. The second box body can be a similar structure to the first, with walls around the edges of a base, but also includes multiple feet extending from the exterior surface of the base and multiple standoffs formed on the interior surface of the base. The feet of the second box body rest on the spacers of the first box body.

In certain embodiments, a stack of patio box assemblies can includes a first patio box assembly (which includes a box body as described herein and a lid with recesses) and a second patio box assembly stacked on top of the first. The second assembly's box body can have feet on its base that are received in the recesses of the first assembly's lid.

In certain embodiments, an outdoor patio box can include a box body with walls around a base, a boss extending from the exterior surface of the base, and a lid to cover the open end of the box body. The lid can include a top panel with multiple channels formed in it.

In certain embodiments of a lid for an outdoor patio box, the lid can include a top panel surrounded by a skirt, multiple channels formed in the top panel, and multiple standoffs depending from the underside of the top panel adjacent to the skirt.

In certain embodiments, an outdoor patio box assembly can include a box body with a base and walls extending from the base, terminating in a lip, and a lid. The lid can include a top panel surrounded by a skirt that engages with the box body's lip, multiple channels in the top panel, and multiple standoffs on the underside of the top panel adjacent to the skirt.

In certain embodiments, a stackable lid assembly for outdoor patio boxes can include two lids, each with a top panel surrounded by a skirt, channels in the top panel, and standoffs on the underside of the top panel. The standoffs of the first lid can be configured to engage with the channels of the second lid when stacked.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a patio box assembly including a box body and a lid, according to one embodiment of the present disclosure;

FIG. 2 a top perspective view of the box body of the patio box assembly shown in FIG. 1;

FIG. 3 is a bottom perspective view thereof;

FIG. 4 a top perspective view of the lid of the patio box assembly shown in FIG. 1;

FIG. 5 is a bottom perspective view thereof;

FIG. 6 is a top perspective view of a lid of the patio box assembly according to another embodiment of the present disclosure;

FIG. 7 a top perspective view of patio box assembly including a box body and a lid, according to another embodiment of the present disclosure;

FIG. 8 is a bottom perspective view of the lid of FIG. 6;

FIG. 9 is a top perspective view of a standoff taken at callout 9 in FIG. 8;

FIG. 10 is a top perspective view of a standoff taken at callout 10 in FIG. 8;

FIG. 11 is a top perspective view of a standoff taken at callout 11 in FIG. 8;

FIG. 12 is a partial cross section and cutaway side elevational view of a stack of two box bodies, according to the box body shown in FIG. 2;

FIG. 13 is an enlarged, side elevational of the stack of two box bodies taken at callout 13 in FIG. 12;

FIG. 14 is a top perspective view of a stack of two of the patio box assemblies of FIG. 1;

FIG. 15 is a top perspective view of a stack of two of the patio box assemblies of FIG. 7;

FIG. 16 is a partial side elevational view of the stack shown in FIG. 15, depicting the bottom of one of the patio box assemblies resting on top of the other patio box assembly; and

FIG. 17 is a cross sectional, side elevational view of a stack of four lids of FIG. 6.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves outdoor storage solutions by addressing certain challenges in the design and functionality of patio boxes. Aspects of the present technology enhance the stability and durability of patio boxes during stacking and storage, facilitate efficient nesting for compact storage and shipping, and incorporate effective water drainage features to prevent water accumulation and associated problems. Additionally, the present technology improves the user experience by eliminating the need for assembly by the end consumer, thereby reducing inconvenience and the risk of incorrect assembly. The present technology also improves storage and shipping efficiency while maintaining structural integrity, addressing the needs of manufacturers and retailers in the transportation and display of patio boxes.

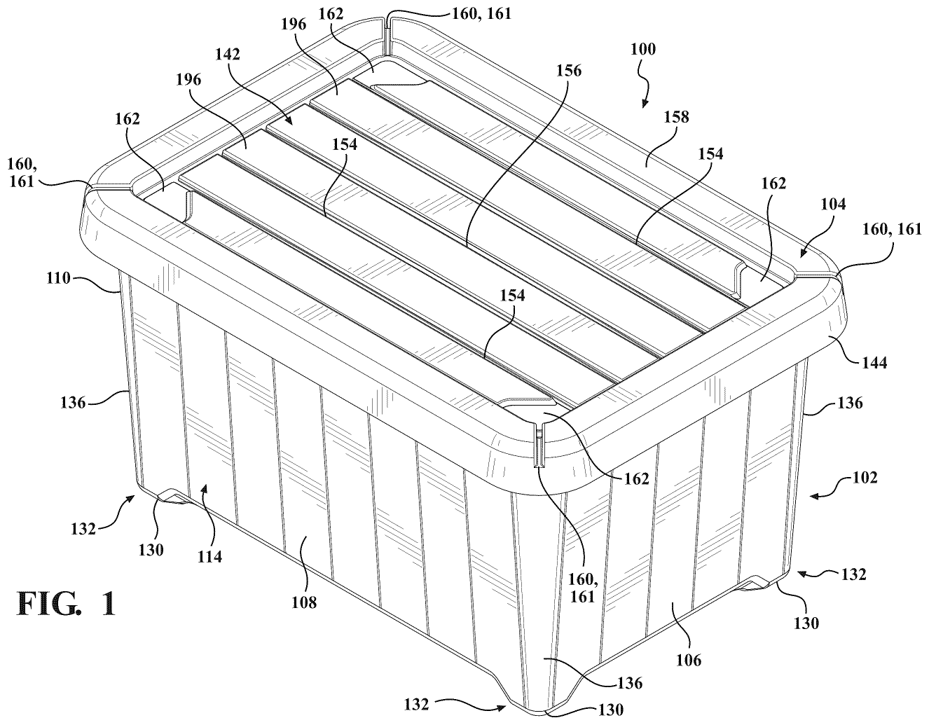

The present technology relates to a patio box assembly 100 for outdoor storage, aspects of which are shown generally in FIGS. 1-17. The patio box assembly 100 can include a box body 102 and a lid 104. The patio box assembly 100 can be used for storing articles such as tools, recreational equipment, supplies, materials, and the like. The patio box assembly 100 can be formed from a solid material. The solid material can allow for the patio box assembly 100 to be stable and durable as it is weathered from the outdoors. Examples include where the patio box assembly 100 is formed from various polyolefins, polypropylene, high density polyethylene (HDPE), and/or polyethylene terephthalate (PET). One of ordinary skill in the art can select other suitable materials for forming the patio box assembly 100 within the scope of the present disclosure.

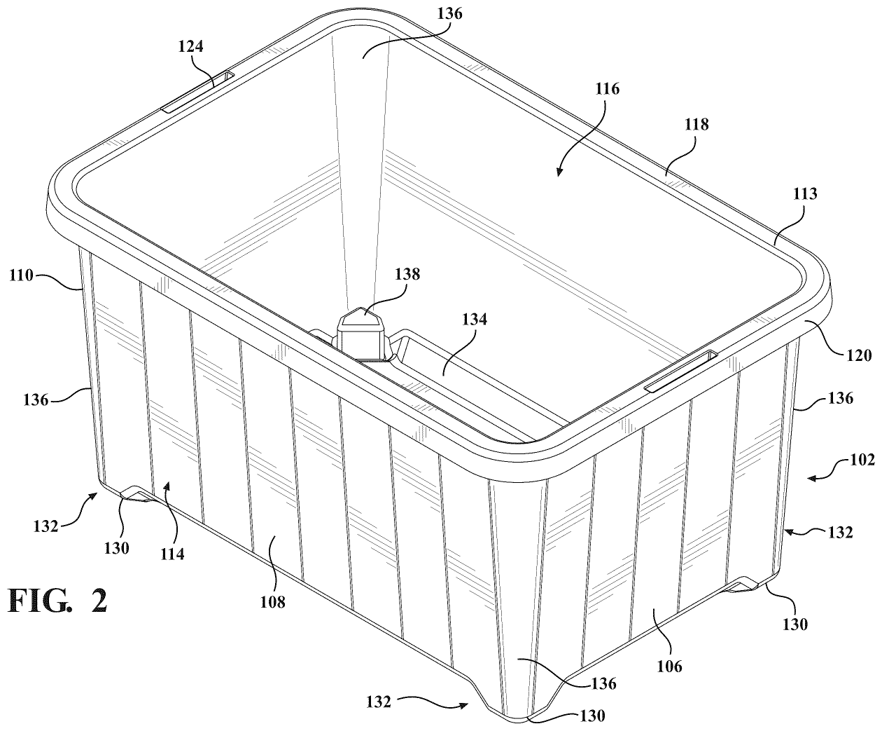

As shown in FIGS. 2-3, 7, and 12-16, the box body 102 can be contiguous having an uninterrupted and unitary structure. In a more specific example, the box body 102 can be injection molded, producing one continuous box body 102 in which each of the components of the box body 102 is formed of the same material. For example, the box body 102 can be injection molded and formed by a single piece of plastic.

The box body 102 can include a front wall 106, a pair of side walls 108, a rear wall 110, and a base 112. The front wall 106 can be disposed adjacent to the side walls 108. The rear wall 110 can be disposed adjacent to the side walls 108 and opposite the front wall 106. Each of the front wall 106, the pair of side walls 108, and the rear wall 110 can be disposed around edges 111 of the base 112. The box body 102 can include an exterior surface 114 and an inner surface 116.

The exterior surface 114 of the front wall 106, the side walls 108, and the rear wall 110 can include various designs formed thereon. For example, as shown in FIGS. 1-3, the outer surface of the front wall 106, the side walls 108, and the rear wall 110 can include the appearance of slats formed thereon. It should be appreciated that a skilled artisan can employ various designs on the outer surface of the box body 102, as desired.

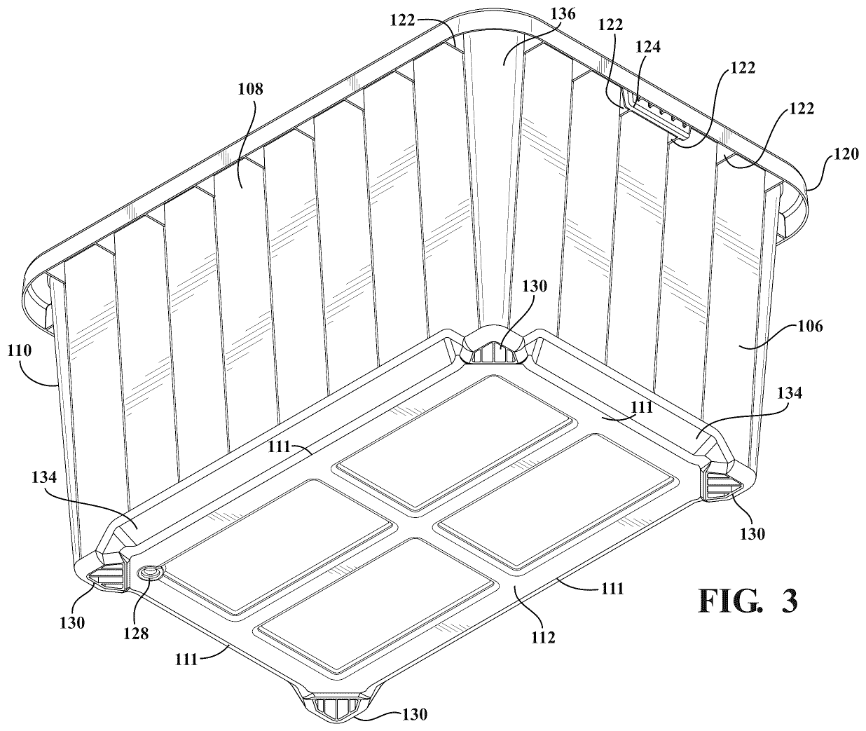

A free edge 113 of each of the front wall 106, the side walls 108, and the rear wall 110 can form a lip 118 of the box body 102. The lip 118 can be circumscribed by a flange 120. In particular, the flange 120 can be substantially orthogonal to the lip 118. The box body 102 can include supports 122 formed between the lip 118, the flange 120, and the exterior surface 114 of the front wall 106, the side walls 108, and the rear wall 110, for example, as shown in FIG. 3. Accordingly, the supports 122 can reinforce the lip 118 by connecting the flange 120 to the outer surfaces 114 of the front wall 106, side walls 108, and rear wall 110. The configuration of the lip 118, the flange 120, and the supports 122 can form a robust structural framework that enhances the overall stability and durability of the box body 102. The supports 122 can help to distribute weight and stress more evenly across the lip 118, which is particularly beneficial when the box body 102 is loaded with heavy items or when multiple box bodies 102 are stacked.

With reference to FIG. 3, handles 124 can be formed between the lip 118 and/or the flange 120 and the exterior surface 114 of the front wall 106 and the rear wall 110. In certain embodiments, the handles 124 can extend from the lip 118 between the flange 120 and the exterior surface 114 of each of the front wall 106 and the rear wall 110. The handles 124 can be generally rectangular projections. The handles 124 can also have supports 122 formed thereon. The handles 124 can provide an ergonomic grip for users, enhancing the ease of lifting and carrying the box body 102. The placement of the handles 124 between the lip 118 and the flange 120 can reinforce the box body 102 at handling stress points, which is particularly beneficial when the box body 102 is heavily loaded and being lifted and can aid to distribute the weight more evenly across the box structure, improving durability and minimizing deformation during handling.

The base 112 of the box body 102 can include a drain 128 formed therein, as shown in FIG. 3, where the drain 128 can allow water or other liquids to exit the box body 102. The drain 128 can be configured to militate against water accumulation inside the box body 102, which could lead to undesired contact with stored items or lead to mold growth. The drain 128 can include a removable plug (not shown), allowing users to selectively open and close the drain as desired, which enables a user to keep the drain closed when not needed, but open it to remove any accumulated water when necessary.

As shown in FIGS. 1-3, the box body 102 can include feet 130 extending from the base 112. In certain embodiments, one of the feet 130 can be formed at each of the corners 132 of an exterior surface 114 the base 112. The feet 130 can be configured to hold the base 112 above the ground surface, in operation. It should be appreciated that the feet 130 can be located along the base 112 at locations other than and/or in addition to the corners 132 of the base 112. For example, on relatively larger box bodies 102, additional feet 130 can be placed at midpoints between the corners 132. A skilled artisan can select a suitable number and arrangement of feet 130 based on the dimensions of the box body 102. In certain embodiments, one or more of the feet can be replaced by or can include wheels (not shown). The feet 130 can also include rubberized grips (not shown) formed thereon or coupled thereto.

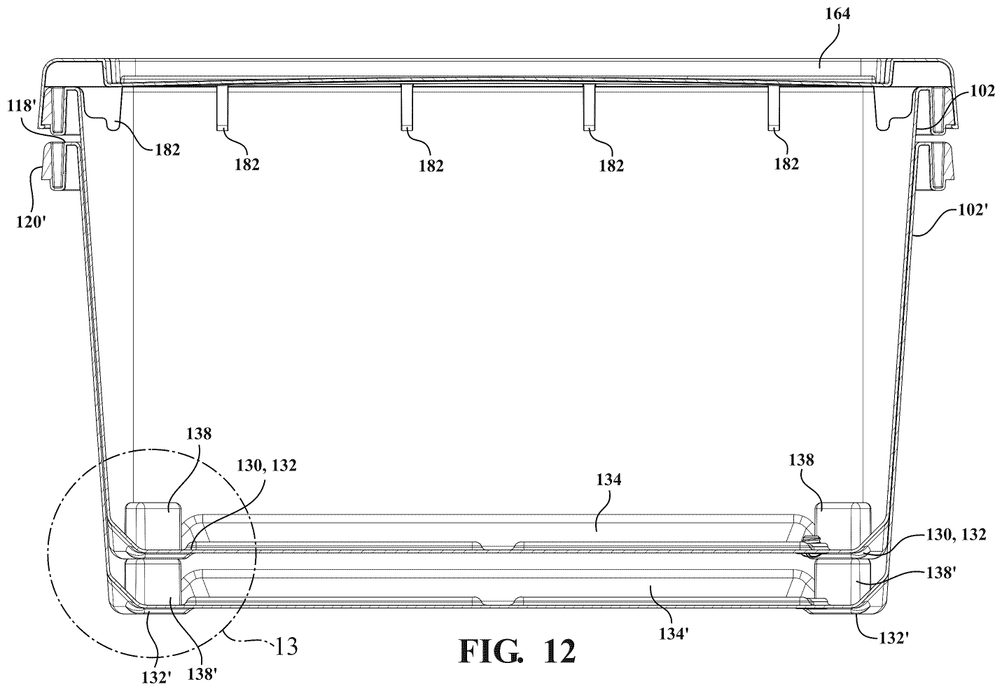

The box body 102 can include tapered walls 134, as shown in FIGS. 2-3 and 12. The tapered walls 134 can be disposed between the base 112 and each of the front wall 106, the side walls 108, and the rear wall 110. Each of the tapered walls 134 can be arranged between the feet 130 of the base 112. As shown in FIG. 12, the box body 102 can be tapered along a height of the box body 102. In particular, the box body 102 can narrow along the height of the box body 102 from the lip 118 to the base 112. In other words, the box body 102 can be wider at the lip 118 than at the base 112. To facilitate the tapering, the box body 102 can include corner walls 136, as depicted in FIGS. 1-2 and 7. The corner walls 136 can be formed between the front wall 106 and each of the side walls 108 and the rear wall 110 and each of the side walls 108. The corner walls 136 can themselves be tapered such that the corner walls are wider adjacent to the lip 118 than adjacent to the base 112. The corner walls 136 can be arcuate, which as described herein, can facilitate in the nesting of box bodies 102.

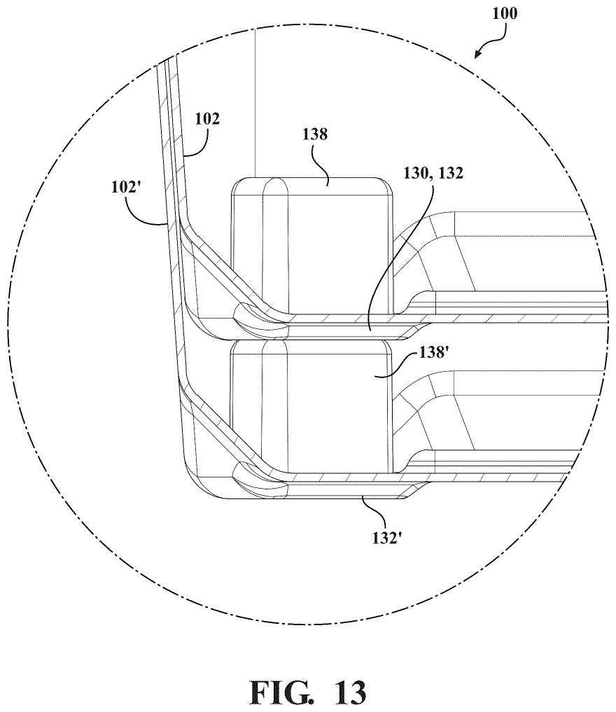

With reference to FIGS. 2 and 12-13, the box body 102 can further include spacers 138 disposed on the interior surface 116 of the base 112. The spacers 138 can extend from the base 112 at the corners 132 and can also be disposed on the corner walls 136. It should be appreciated that the spacers 138 can be disposed in the box body 102 opposite of the feet 130. In operation, a box body 102 can be stacked within another box body 102. When the box bodies 102 are stacked, each of the feet 130 of one box body 102 can rest on a respective spacer 138 of the other box body 102′, for example, as shown in FIG. 12-13. In embodiments with wheels, the wheels can likewise interact with the spacers 138. Advantageously, the feet 130 and the spacers 138 can militate the exterior of the base 112 of one box body 102 from being directly disposed on the interior of the other box body 102′. It should be understood that militating against the exterior of the base 112 of one box body 102 from being directly disposed on the interior of the other box body 102 can facilitate the removal of one box body 102 from the interior of the other box body 102.

Several features of the box bodies 102 operate in combination to allow the box bodies 102 to nest efficiently within one another. The tapered walls 134, which are disposed between the base 112 and each of the front wall 106, side walls 108, and rear wall 110, create a narrowing profile along the height of the box body 102 from the lip 118 to the base 112. The tapering effect can be further enhanced by the corner walls 136, which are formed between the front wall 106 and each of the side walls 108, as well as between the rear wall 110 and each of the side walls 108. The corner walls 136 can also be tapered, being wider adjacent to the lip 118 than adjacent to the base 112, and an arcuate shape of the corner walls 136 specifically facilitates the nesting of box bodies 102. The tapering of the tapered walls 134 and corner walls 136 can serve to guide the placement of one box body 102 within another box body 102′, providing smooth stacking and removal therebetween. This not only facilitates easy stacking and unstacking but also helps distribute weight evenly across the structure.

The spacers 138, disposed on the interior surface 116 of the base 112 at the corners 132 and on the corner walls 136, can work in conjunction with the feet 130 (or wheels in certain embodiments) to ensure proper spacing between stacked box bodies 102. When box bodies 102 are stacked, each of the feet 130 rests on one of the spacers 138, preventing direct contact between the exterior of the base 112 of one box body 102 and the interior of another box body 102′. The tapered walls 134, corner walls 136, spacers 138, and feet 130 (or wheels) not only allow for efficient nesting, but also maintain stability when multiple box bodies are stacked. The tapered walls 134, corner walls 136, spacers 138, and feet 130 militate against the exterior of the base 112 of one box body 102 from being directly disposed on the interior of the other box body 102′, which enhances the overall durability and functionality of the stacked assembly. This integrated approach to a nesting configuration addresses the need for improved storage and shipping solutions.

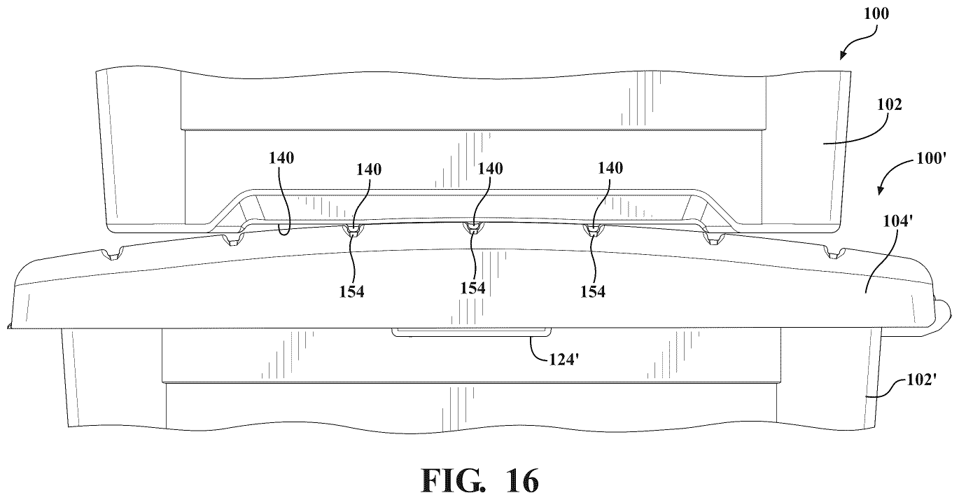

The box body 102 can further include bosses 140 disposed on the exterior surface 114 of the base 112, as depicted in FIG. 16. The bosses 140 can extend outwardly from the exterior surface 114 of the base 112 and can be generally parallel to each other and the front wall 106 and the rear wall 110. The bosses 140 can increase a rigidity of the base 112. Additionally, and as further described herein below, the bosses 140 can cooperate with the lid 104 to facilitate stacking one patio box assembly 100 on top of another patio box assembly 100. In particular, the bosses 140 on one box body 102 can cooperate with the lid 104′ associated with another box body 102′,

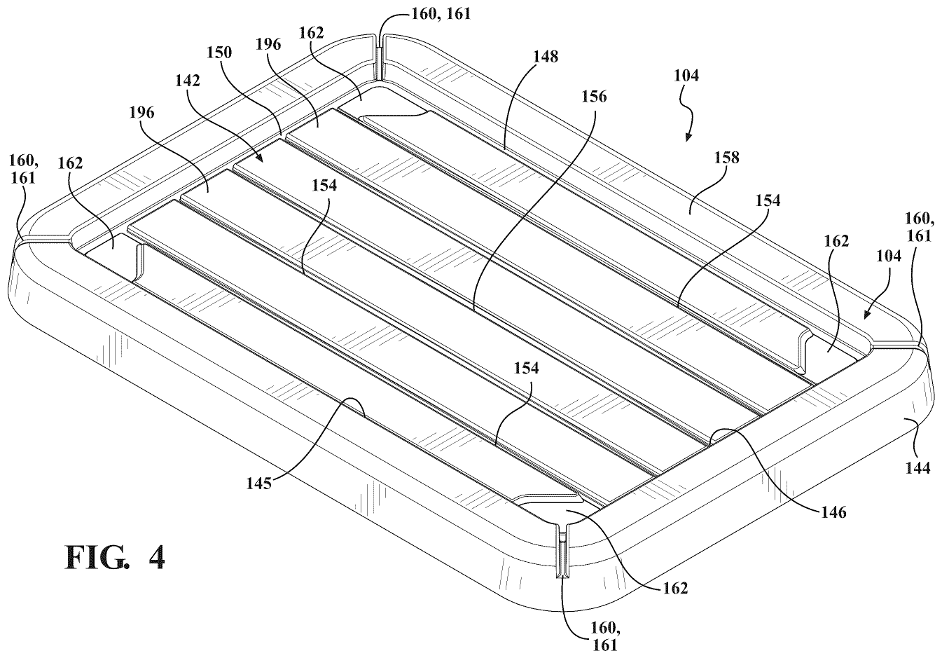

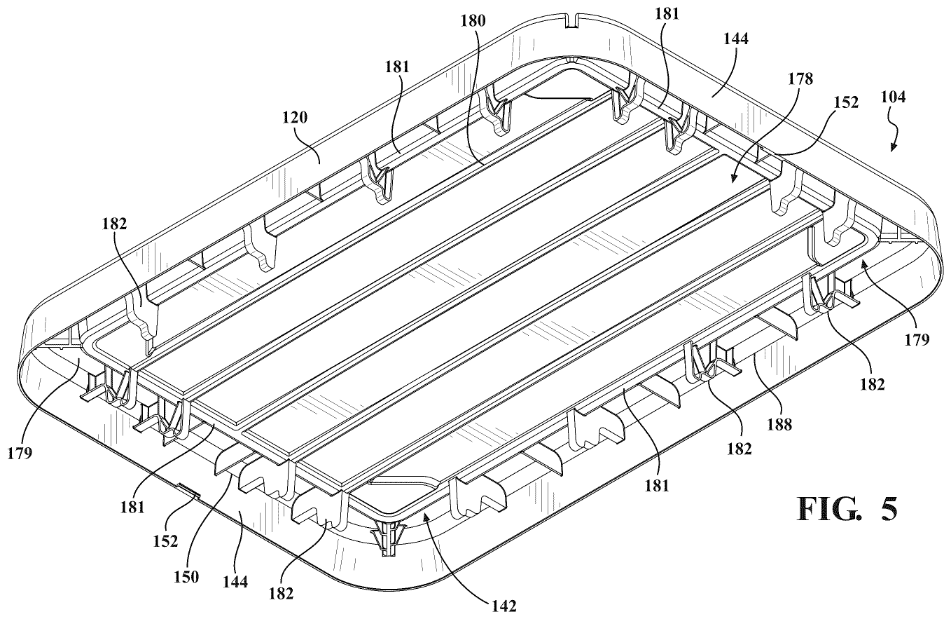

With reference to FIGS. 4-5, the lid 104 can include a top panel 142 circumscribed by a skirt 144. The top panel 142 can have a front edge 146, a pair of side edges 148, and a rear edge 150. The skirt 144 can be disposed along the front edge 146, the pair of side edges 148, and the rear edge 150 of the top panel 142. The skirt 144 can be configured to engage the lip 118 of the box body 102, in operation.

In particular, the skirt 144 of the lid 104 can be configured to provide a snap fit with the lip 118 of the box body 102. With refence to FIG. 5, the skirt 144 can include a tab 152 disposed on and/or formed in the skirt 144. In the illustrated embodiment, the tab 152 is formed adjacent a terminal bottom end of the skirt 144 along the edges 146, 148, 150. The skirt 144 and the tab 152 can be configured to engage the flange 120 of the box body 102, in operation. In particular, the skirt 144 and the tab 152 of the lid 104 can be configured to provide a snap fit with the flange 120 of the box body 102. It should be understood that additional tabs 152 can be provided on the skirt 144 of the lid 104 and a skilled artisan can select a suitable number and location of the tabs 152 to provide a desired snap attachment strength of the lid 104 to the box body 102.

The top panel 142 can include a plurality of channels 154 formed therein. The channels 154 can be disposed along a length of the top panel 142. The channels 154 can be substantially parallel to the adjacent channels 154. In certain embodiments, one of the channels 154 can generally circumscribe the top panel 142 adjacent to the skirt 144, for example, as shown in FIG. 4.

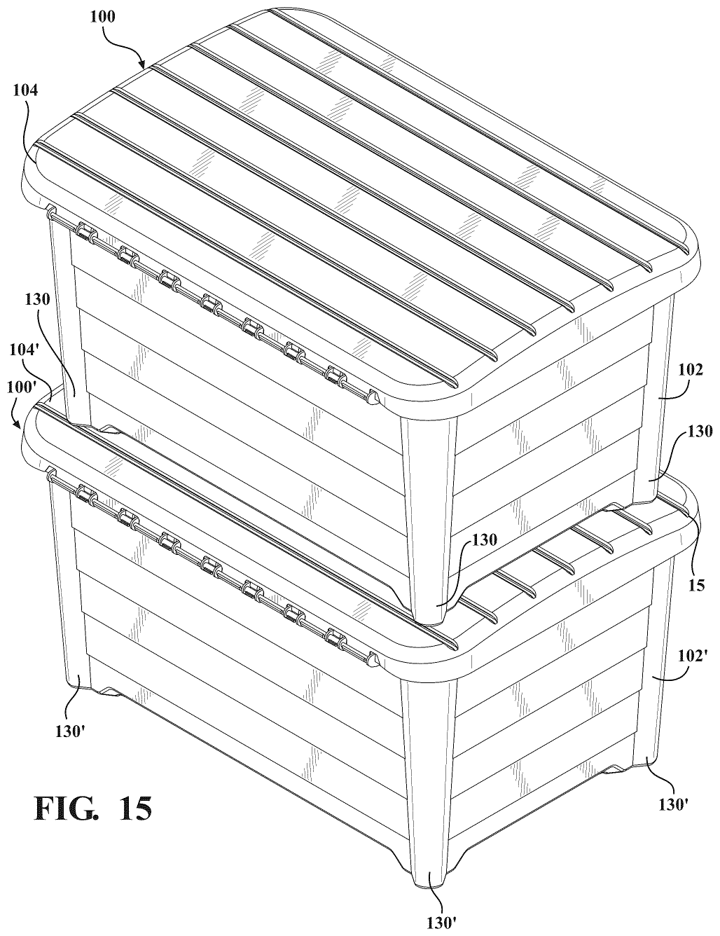

With reference to FIG. 16, the box body 102 can include bosses 140 disposed on the exterior surface 114 of the base 112. The bosses 140 extend outwardly from the exterior surface 114 of the base 112 and are generally parallel to each other and to the front wall 106 and rear wall 110. As shown in FIG. 15, when the patio box assemblies 100 are stacked, each of the bosses 140 of the upper box body 102 is configured to engage with a respective one of the channels 154 of the lid 104 of the lower patio box assembly 100′. This interaction between the bosses 140 and the channels 154 creates an interlocking mechanism that enhances the stability of the stacked configuration. The engagement of the bosses 140 with the channels 154 helps to prevent lateral movement or sliding between the stacked patio box assemblies 100, providing a more secure and stable arrangement.

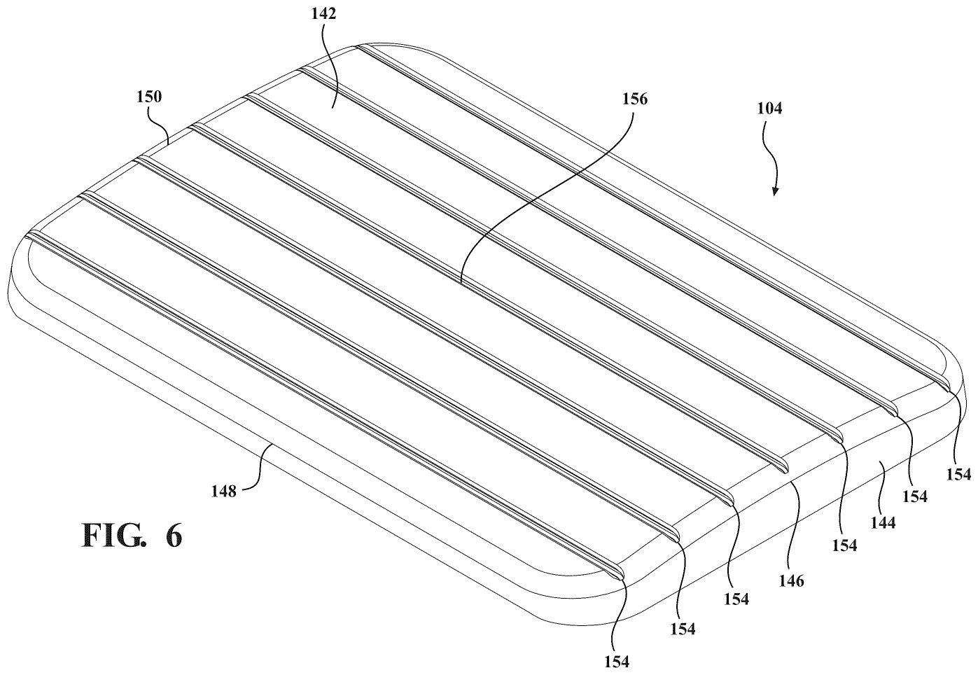

In certain embodiments, for example shown in FIGS. 6-8, the top panel 142 of the lid 104 can have an arcuate or curved shape. A center point 156 of the top panel 142 can be elevated compared to the front edge 146, the pair of side edges 148, and the rear edge 150 of the top panel 142, creating a dome-like structure. The skirt 144 can also be positioned below this center point 156, following the curvature of the top panel 142. The arcuate shape of the lid 104 in this embodiment allows for efficient water runoff, as the curved surface naturally directs water towards the edges of the lid 104. The channels 154 can further direct water toward the front edge 146 and the rear edge 150.

With reference again to FIGS. 4-5, the top panel 142 of the lid 104 can be configured to be lower than the skirt 144, which creates a recessed surface where the top panel 142 sits below an upper edge 158 of the surrounding skirt 144. Advantageously, this configuration creates a recessed surface on the lid 104, effectively forming a shallow basin surrounded by the elevated skirt 144. The raised skirt 144 can act as a barrier around the perimeter of the lid 104, creating a containment area for the base 112 of another patio box assembly 100 placed on top. This can militate against the upper patio box assembly 100 from sliding off, especially when stacked on uneven surfaces or during transportation.

The lid 104 can incorporate one or more water drainage features to enhance functionality and durability in outdoor environments. The skirt 144 can include water drainage channels 160 formed therein. In certain embodiments, the skirt 144 can include one water drainage channel 160 disposed at each of the corners 161, as shown in FIG. 4. The water drainage channels 160 can be in fluid communication with the top panel 142. The water drainage channels 160 can extend through the skirt 144 from the top panel 142 to an exterior of the lid. Where the skirt 144 is disposed above the top panel 142, the water drainage channels 160 can therefore be configured to allow water (e.g., rainwater) to flow from the top panel 142 through the water drainage channel 160 and off the lid 104.

To further assist in water drainage, the lid 104 can be tapered such that the central point 156 of the top panel 142 of the lid 104 is disposed above the front edge 146, the pair of side edges 148, and the rear edge 150 of the top panel 142 of the lid 104. The central point 156 can be higher relative to the water drainage channels 160 disposed at the corners 161, allowing gravity flow of water off of the lid 104. Advantageously, this can allow water to run downward and through the channels 154, to the water drainage channel 160, and off the lid 104. A skilled artisan can select a suitable taper or height differential between the central point 142 and the front edge 146, the pair of side edges 148, and the rear edge 150 of the top panel 142 of the lid to provide enough slope to allow for water to flow through the water drainage channels 160, in operation. A skilled artisan can select a suitable number and placement of water drainage channels 160 based on dimensions of the lid 104.

The lid 104 can incorporate recesses 162 formed in the top panel 142. The recesses 162 can be configured to have a shape that corresponds with the feet 130 of the box body 102. The recesses 162 can allow for a more secure and stable stacking arrangement when multiple patio boxes 100 are stacked. When stacking the patio boxes 100, the feet 130 of one box body 102 are configured to fit within the recesses 162 of the lid 104 of another patio box assembly 100 positioned beneath it. This interlocking mechanism improves stability by creating a more stable stacking configuration, reducing the likelihood of boxes shifting or toppling when stacked. The alignment of the feet 130 with the recesses 162 also improves weight distribution, as the weight of the upper box is more evenly distributed across the lid of the lower box, potentially reducing stress on any single point of the lid. Additionally, the recesses 162 can act as guides for the feet 130, making it easier for users to correctly align and stack multiple patio box assemblies 100.

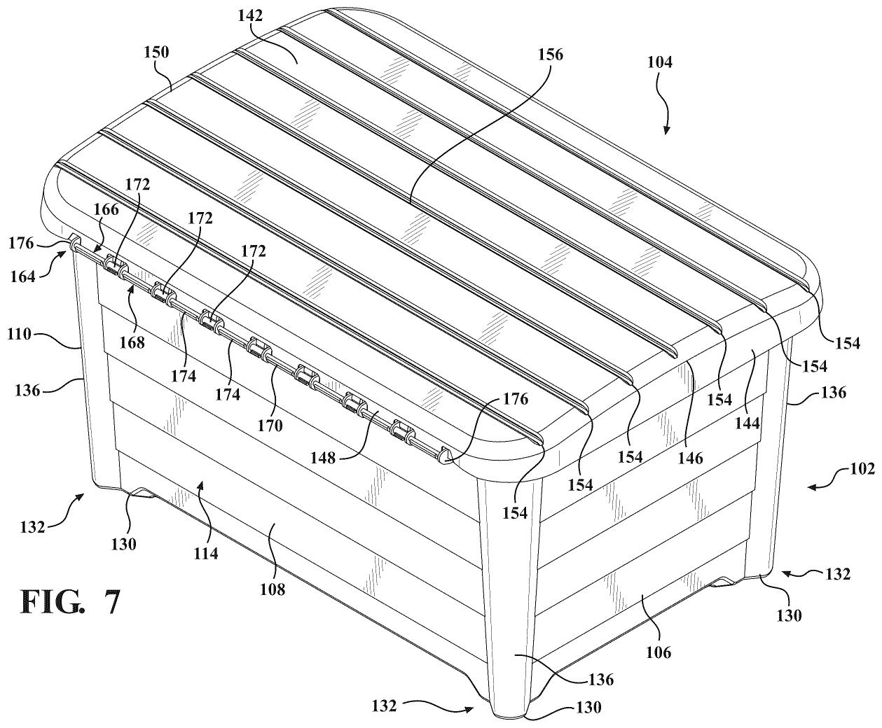

While the lid 104 can be configured to provide a snap fit with the flange 120 of the box body 102, as previously discussed, the lid 104 can also be hingedly coupled to the box body 102, for example, as shown in FIG. 7. The patio box assembly 100 can incorporate a hinge 164 that allows the lid 104 to be pivotally connected to the box body 102. The hinge 164 can include two main components: a first member 166 and a second member 168. The first member 166 can be integrally formed in the flange 120 and can extend outwardly from the exterior surface of the flange 120 of the box body 102. The first member 166 can include a rod 170 that is spaced apart from the flange 120 and supported by a plurality of spaced apart tabs 172. The tabs 172 can be formed between the flange 120 and the exterior surface 114 of the side wall 108, extending outwardly from the flange 120 to support the rod 170. The second member 168 of the hinge 164 can be integrally formed with the skirt 144 along the rear edge 150 of the lid 104. The second member 168 can include a plurality of spaced apart connectors 174 and retention tabs 176. The connectors 174 are configured to couple with the rod 170 of the first member 166, allowing the lid 104 to pivot about the rod 170. Each connector 174 can be positioned between two successive tabs 172 of the first member 166.

To ensure the lid 104 remains securely attached to the box body 102, the retention tabs 176 can be configured to abut or be adjacent to the outer surface of the rod 170. This configuration helps maintain the connectors 174 in a coupled relationship with the rod 170, militating against accidental detachment of the lid 104 from the box body 102. The hinge 164 can offer several advantages. It allows for easy access to the contents of the patio box 100 without completely removing the lid 104, which can be particularly convenient in outdoor settings. The integrated nature of the hinge components with the box body 102 and lid 104 also ensures durability and weather resistance, which are important factors for outdoor storage solutions.

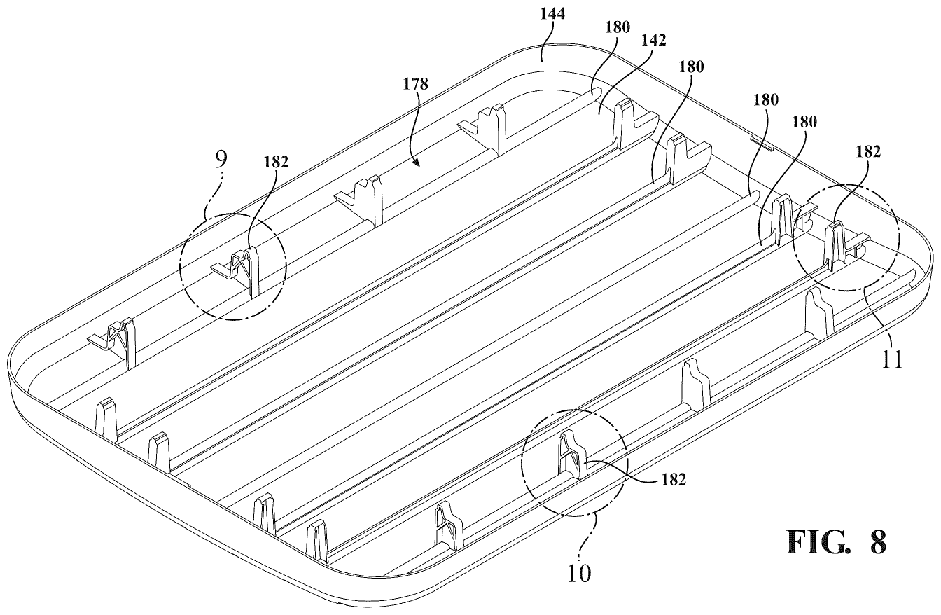

With reference to FIGS. 5 and 8, an underside 178 of the top panel 142 of the lid 104 can include ridges 180. The ridges 180 can correspond to the channels 154 on the top panel 142. The ridges 180 can serve to reinforce the structure of the lid 104, providing additional rigidity while maintaining a lightweight design. The ridges 180 can allow for a more uniform thickness of the lid 104 material, enhancing overall strength and durability of the lid 104.

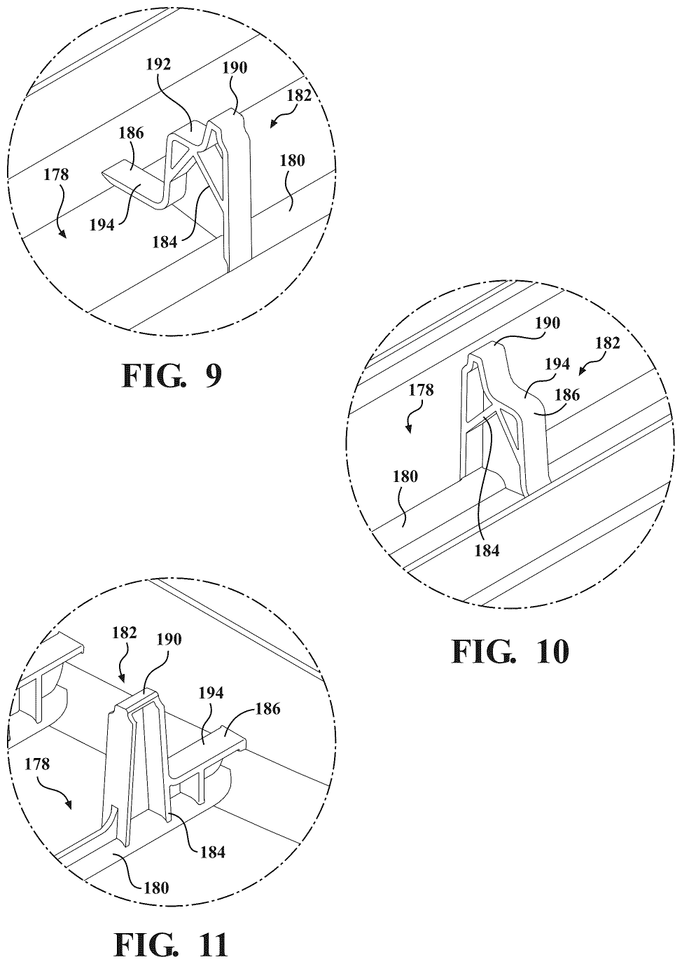

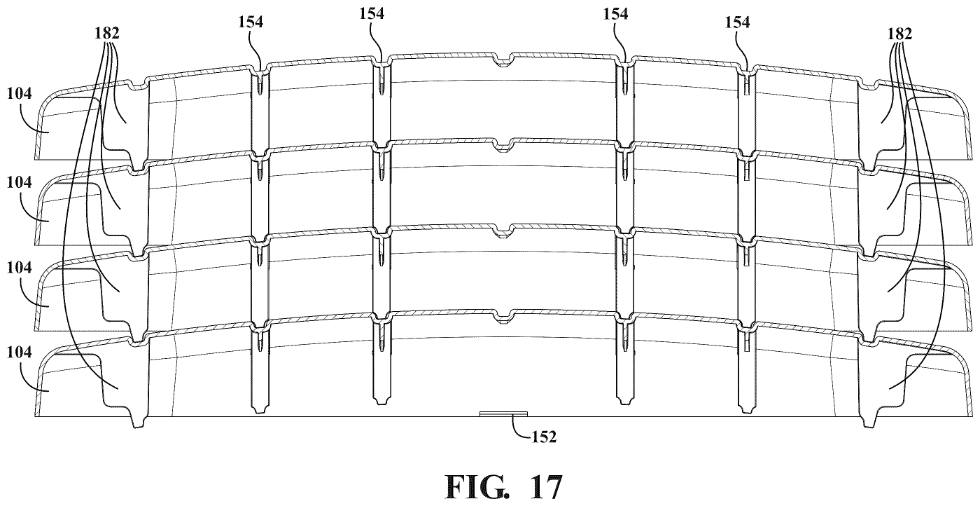

The underside 178 of the lid 104 can also include a plurality of standoffs 182 that depend from therefrom. The standoffs 182 can be strategically placed protrusions formed in the top panel 142 adjacent to or as part of the skirt 144. The standoffs 182 can be narrow, with a height greater than a width, and may include one or more support ribs 184 to enhance their rigidity, as depicted in FIGS. 9-11. The standoffs 182 can be configured with one or more planar contact surfaces 186, which can serve dual functions: help guide and align the lid 104 onto the box body 102 and interact with portions of another lid 104 when the lids 104 are stacked, as shown in FIG. 17.

Turning to FIG. 8, the standoffs 182 can extend from the underside 178 of the top panel 142 adjacent to the skirt 144 and one of the ridges 180 that correspond to the channels 154 on the top panel 142. The placement of the standoffs 182 adjacent to the skirt 144 and one of the ridges 180 helps to reinforce the lid 104, particularly where the curved top panel 142 meets the skirt 144. By aligning the standoffs 182 with one of the ridges 180 on the underside 178 of the top panel 142, the standoffs 182 can help distribute forces more evenly across the lid 104 when in use or when lids 104 are stacked, potentially reducing stress on any single point of the lid 104.

With reference to FIGS. 4-5, the lid 104 of the patio box assembly 100 is configured with the top panel 142 positioned lower than the surrounding skirt 144. As a result of this inlaid configuration, a boss 179 is formed on the underside 178 of the lid 104. The boss 179 is a structural feature that occurs due to the height difference between the lower top panel 142 and the higher skirt 144. The boss 179 can be defined by an outer wall 188 of the skirt 144 and one of the ridges 181 that circumscribes the top panel 142 of the lid 104. In certain embodiments, the standoffs 182 extend laterally from the ridge 181 that circumscribes the top panel 144, across the width of the boss 179.

The arrangement of the standoffs 182 on the underside 178 of the lid 104 can be configured to complement the structure of the box body 102. When the lid 104 is closed, the standoffs 182 can interact with the interior 116 of the box body 102, providing stability and ensuring a proper fit. Additionally, when multiple lids 104 are stacked, for example as shown in FIG. 17, the standoffs 182 of one lid 104 can engage with the channels 154 or recesses of another lid 104, contributing to the overall stability of the stacked configuration.

As shown in FIGS. 9-11, the standoffs 182 can include a plurality of planar contact surfaces 186. The planar contact surfaces 186 can be generally arranged in a stair-step fashion. In other words, the planar contact surfaces 186 can increase in height when moving laterally from the skirt 144 to the top panel 142 of the lid 104. In certain embodiments, the planar contact surfaces 186 can include an upper contact surface 190, a middle contact surface 192, and a lower contact surface 194. In other embodiments, the planar contact surfaces 186 can include only the upper contact surface 190 and the lower contact surface 194. For example, where two lids 104 are stacked, the upper contact surface 190 of a first lid 104 can be received by the channel 154 of the other lid 104. The middle contact surface 192 of the first lid 104 can be received by one of the surface features 196 of the second lid 104. The lower contact surface 194 can be received by the skirt 144 of the second lid 104. It should be appreciated that the lid 104 can include multiple distinct types of standoffs 182 having varying arrangements of planar contact surfaces 196, for example, as shown in FIGS. 5 and 8-11. The particular arrangement and types of standoffs 182 can be selected by a skilled artisan based on dimensions of the particular lid 104.

Additionally, it should be understood that stacking of a lid 104 and another lid 104, being of similar design, result in an alignment of the respective standoffs 182 about a same axis substantially orthogonal with the top panel 142 of the lid 104 and the another one of the lid 104. This alignment upon stacking effectively results in a supporting rod or column of material disposed through the thickness of the stacked assembly of lids 104, as shown in FIG. 17. Advantageously, this effect contributes to a strength or robustness of the stack assembly of lids 104 in view of weight and stresses experienced by individual lids 104. When stacked, the standoffs 182 of the lid 104 can limit a depth of a stacked lid 104 received thereby. By limiting the depth of one lid 104 within another lid 104, deformation otherwise presented by exterior surfaces of the skirt 144 and bosses 140 pressing outwardly on corresponding interior surfaces is advantageously militated against during storage or transport.

As described herein, the patio box assembly 100 is configured to allow for efficient stacking and nesting of its components, providing versatile storage and transportation options. The lids 104 can be configured to stack efficiently with one another, for example as shown in FIG. 17. Each lid 104 includes a plurality of standoffs 182 depending from its underside 178. The standoffs 182 can engage with the channels 154 formed in the top panel 142 of another lid 104 positioned beneath it. When stacked, the standoffs 182 of the upper lid 104 are received by the channels 154 of the lower lid 104. This interlocking mechanism facilitates maintaining the lids 104 in a stable stacked configuration and militates against sliding of the lids 104 relative to one another. The box bodies 102 are designed to nest within one another, for example as shown in FIG. 12, optimizing space during storage and transportation. When nested, the feet 130 of an upper box body 102 rest on the spacers 138′ disposed on the interior surface 116′ of the base 112′ of the lower box body 102′. This configuration militates against the exterior surface 114 of the base 112 of the upper box body 102 from directly contacting the interior surface 116′ of the lower box body 102′.

The tapered walls 134 of the box bodies 102, which narrow along the height from the lip 118 to the base 112, further facilitate the nesting process by guiding one box body into another. The corner walls 136, which are formed between the front wall 106 and each of the side walls 108, as well as between the rear wall 110 and each of the side walls 108, are also tapered and have an arcuate shape that specifically facilitates the nesting of box bodies 102.

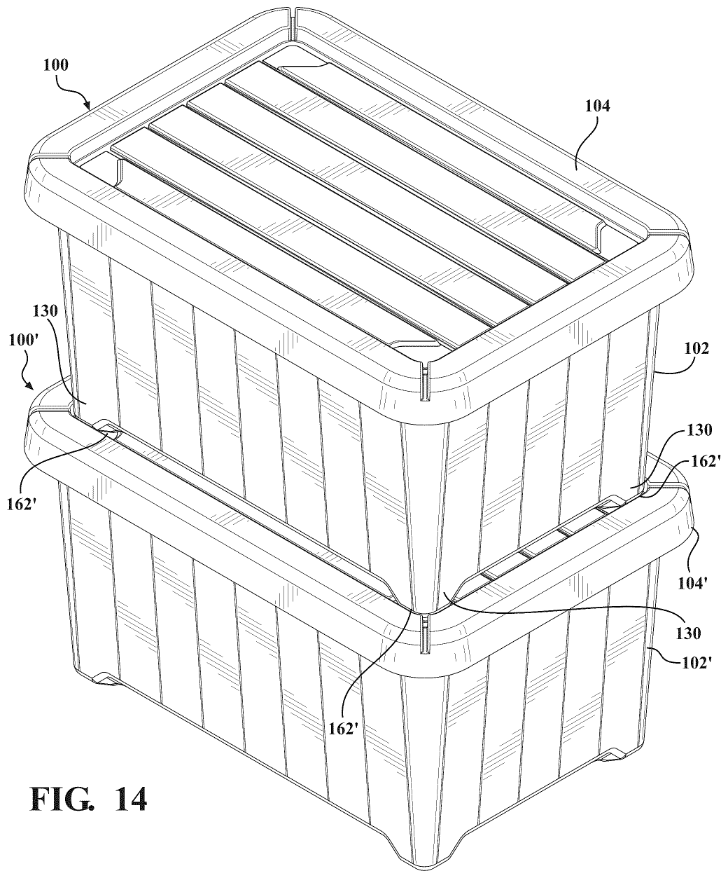

As shown in FIGS. 14-15, the patio box assembly 100 can be configured to allow for secure stacking of complete units. When stacking assembled patio box assemblies 100, the lid 104 of the lower assembly interacts with the base 112′ of the upper assembly 100′. The bosses 140′ formed on the exterior surface 114′ of the base 112′ of the upper box body 102′ can be configured to engage with the channels 154 formed in the top panel 142 of the lid 104 of the lower assembly, for example, as shown in FIGS. 15-16. The engagement between the bosses 140 and channels 154 creates an interlocking mechanism that enhances the stability of the stacked configuration and helps prevent lateral movement or sliding between the stacked patio box assemblies 100. In the embodiment with the inlaid lid as shown in FIG. 14, the recesses 162 formed in the top panel 142 of the lid 104 are designed to correspond with the feet 130 of the box body 102. When stacking complete assemblies 100, the feet 130 of the upper box body 102 fit into these recesses 162′ on the lid 104′ of the lower assembly 100′. This further improves the stability of the stack and helps distribute weight more evenly across the lid of the lower box.

Advantageously, the present disclosure addresses shortcomings in outdoor storage solutions by providing a patio box assembly that enhances stability and durability during stacking and storage, facilitates efficient nesting for compact storage and shipping, and incorporates effective water drainage features to prevent water accumulation and associated problems. The present technology reduces the need for assembly by the end consumer, minimizing inconvenience and the risk of incorrect assembly. The configuration of the patio box assembly, including features such as the tapered walls, strategically placed standoffs, and interlocking mechanisms between components, improves storage and shipping efficiency while maintaining structural integrity. This comprehensive solution addresses the needs of manufacturers, retailers, and end-users by providing a versatile, durable, and user-friendly outdoor storage option that overcomes the limitations of other patio box designs.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A patio box, comprising:
a box body including:
a front wall,
a pair of side walls,
a rear wall, and
a base, wherein the front wall, the pair of side walls, and the rear wall are disposed around edges of the base,
a foot formed on an exterior surface the base, and
a spacer formed on an inner surface of the base opposite of the foot.

2. The patio box of claim 1, wherein the box body further includes a lip formed by a free edge of the front wall, the pair of side walls, and the rear wall.

3. The patio box of claim 2, wherein the lip is circumscribed by a flange.

4. The patio box of claim 3, further comprising supports formed between the flange and an exterior surface of the front wall, the pair of side walls, and the rear wall.

5. The patio box of claim 2, further comprising handles formed between the lip and an exterior surface of the front wall and the rear wall.

6. The patio box of claim 1, wherein the foot is comprised by a plurality of feet, each foot formed at a corner of the exterior surface of the base.

7. The patio box of claim 1, wherein the box body includes tapered walls disposed between the base and each of the front wall, the pair of side walls, and the rear wall.

8. The patio box of claim 7, wherein the box body narrows along a height of the box body from a lip to the base.

9. The patio box of claim 1, further comprising corner walls formed between the front wall and each of the side walls and formed between the rear wall and each of the side walls.

10. The patio box of claim 9, wherein the corner walls are arcuate.

11. The patio box of claim 1, further comprising bosses disposed on the exterior surface of the base.

12. The patio box of claim 1, further comprising a lid configured to selectively cover an open end of the box body.

13. The patio box of claim 12, further comprising a hinge connecting the lid to the box body.

14. A stack of patio boxes, comprising:
of patio boxes, each patio box including a patio box according to claim 1;
wherein the foot of one patio box of the pair of patio boxes rests on the spacer of the other patio box of the pair of patio boxes.

15. A stack of patio box assemblies, comprising:
a first patio box assembly including:
a box body including:
a front wall,
a pair of side walls,
a rear wall, and
a base, wherein the front wall, the pair of side walls, and the rear wall are disposed around edges of the base,
a foot formed on an exterior surface the base, and
a first lid disposed on an open end of the first box body, the first lid including a top panel having a plurality of recesses formed therein;
a second patio box assembly stacked on top of the first patio box assembly, the second patio box assembly including:
a box body including:
a front wall,
a pair of side walls,
a rear wall, and
a base, wherein the front wall, the pair of side walls, and the rear wall are disposed around edges of the base,
a foot formed on an exterior surface the base,
wherein the plurality of feet of the base of the second patio box assembly are received in the plurality of recesses of the first lid.

16. A patio box assembly, comprising:
a box body including:
a front wall,
a pair of side walls,
a rear wall,
a base, wherein the front wall, the pair of side walls, and the rear wall are disposed around edges of the base, and
a boss extending from an exterior surface the base; and
a lid configured to selectively cover an open end of the box body, the lid including a top panel having a plurality of channels formed therein.

17. The patio box assembly of claim 16, wherein the top panel of the lid is arcuate.

18. The patio box assembly of claim 16, wherein the boss of the base of the box body has a shape that correlates with a shape of the channels of the lid.

19. The patio box assembly of claim 16, wherein the base includes a plurality of bosses extending therefrom.

20. A stack of patio box assemblies, comprising:
a first patio box assembly according to claim 16; and
a second patio box assembly stacked on top of the first patio box assembly, the second patio box assembly including a second box body having a base with a plurality of bosses extending from an exterior surface of the base, wherein the plurality of bosses of the base of the second patio box assembly engage with the plurality of channels of the lid of the first patio box.
